(19) United States
(12) Patent Application Publication
(10) Pub. No.: US 2023/0382725 A1
(43) Pub. Date: Nov. 30, 2023

(54) BENZENE BATTERY CYCLE

(71) Applicant: Joseph Barrett Bland, Sacramento, CA (US)

(72) Inventor: Joseph Barrett Bland, Sacramento, CA (US)

(21) Appl. No.: 18/197,092

(22) Filed: Aug. 21, 2023

Related U.S. Application Data
(60) Provisional application No. 63/342,093, filed on May 14, 2022.

(51) Int. Cl. C01B 3/00; B01J 19/00; F02M 21/02; F02M 21/06; H01M 8/0612; H01M 8/18

(52) U.S. Cl. CPC C01B 3/0015; B01J 19/0013; F02M 21/0287; F02M 21/06; H01M 8/0612; H01M 8/182; B01J 2219/00103

(57) ABSTRACT

The present invention proposes a thermochemical battery cycle, termed a Benzene Battery cycle, for efficiently storing electric and/or thermal energy for later and/or distant use. The methods and apparatus herein proposed utilize reversible endothermic fluid and exothermic fluid thermochemical means for efficiently storing H2 in a liquid state at STP. The present invention is generally based on the technology disclosed in U.S. Pat. Nos. 3,225,538, 3,067,594, and 3,871,179, wherein techniques are described for creating a unique thermochemical cycle, termed the Bland/Ewing Cycle (B/E Cycle) after the co-inventors, involving “molecular expansion” and “molecular compression”. The present invention is also based on US Patent Application #18-0954634 which proposes optimizing endothermic and exothermic “segments” for the creation of either Combined Heat and Power (CHP) or Combined Cycle (CC) applications.

### CROSS-REFERENCE TO RELATED APPLICATIONS

This application claims the benefit of provisional patent application EFS ID 45714697, Application Ser. No. 63/342,093, filed 14 May 2022 by the present inventor, which is incorporated by reference in its entirety.

### PRIOR ART

This field is related to heat engine cycles based on U.S. Pat. Nos. 3,225,538, 3,067,594, and 3,871,179.

### BACKGROUND

It is proposed that reversible endothermic and exothermic fluid thermochemical means be used for efficiently storing and utilizing H2 in the form of a thermochemical battery rather than an electrochemical battery. An example of an endothermic fluid is cyclohexane (C6H12). An example of an exothermic fluid is benzene (C6H6) plus hydrogen (H2). Since the process revolves around the use of benzene (C6H6) as a means of cyclically storing and giving off H2, the process is termed the “Benzene Battery” (BB) cycle. By reversible is meant that the elements of a BB cycle are completely contained in a cyclical process that requires only the input and removal of thermal energy to continually operate. By allowing H2 to be stored in a liquid state at Standard Temperature and Pressure (STP), the BB cycle is seen as useful for efficiently storing electricity and/or heat energy for later and/or distant use.

Essential to the function of a BB cycle is the Bland/Ewing (B/E) thermochemical heat engine cycle (B/E Cycle) proposed in U.S. Pat. No. 3,225,538, and in part in U.S. Pat. Nos. 3,067,594 and 3,871,179. The present invention proposes methods and apparatus for improving the technology disclosed in U.S. Pat. Nos. 3,225,538, 3,067,594, and 3,871,179, wherein techniques are detailed for creating a unique thermochemical cycle involving “molecular expansion” and “molecular compression”, termed the Bland/Ewing Cycle (B/E Cycle) after the co-inventors.

Also essential to the function of a BB cycle is the proposal to segment the B/E Cycle into endothermic and exothermic segments, proposed in US Patent Application #18-0954634. As shown in US Patent Application #18-0954634, a complete Bland/Ewing Combined Heat and Power (B/E-CHP) cycle or Bland/Ewing Combined Cycle (B/E-CC) is composed of an endothermic segment and an exothermic segment.

The various endothermic and exothermic segments described in US Patent Application #18-0954634 are referentially included herein.

### SUMMARY

It is proposed that reversible endothermic and exothermic fluid thermochemical means be used for efficiently storing and utilizing H2 in the form of a thermochemical battery rather than an electrochemical battery. By allowing H2 to be stored in a liquid state at STP, the BB cycle is seen as useful for efficiently and inexpensively storing electric and/or thermal energy for later and/or distant use.

The present invention proposes a thermochemical battery cycle. By allowing H2 to be stored in a liquid state at STP, the BB cycle is seen as useful for efficiently and inexpensively storing electric and/or thermal energy for later and/or distant use. The present invention is generally based on U.S. Pat. Nos. 3,225,538, 3,067,594, and 3,871,179, wherein techniques are described for creating a unique thermochemical cycle, termed the Bland/Ewing Cycle (B/E Cycle) after the co-inventors, involving “molecular expansion” and “molecular compression”. The present invention is also based on US Patent Application #18-0954634 which proposes optimizing endothermic and exothermic “segments” for the creation of either Combined Heat and Power (CHP) or Combined Cycle (CC) applications.

### BRIEF DESCRIPTION OF THE DRAWINGS

The invention will be illustrated in greater detail by description in connection with specific examples of the practice of it and by reference to the accompanying drawings, in which:

FIG. 1 is a work diagram of one possible approach to constructing a B/E endothermic cycle segment as applicable to the generation of endothermic fluid for use in a BB cycle. The following key is provided for FIG. 1: A. C6H12 storage outlet; B. C6H12 pump outlet; C. C6H12 condenser/evaporator/cooler outlet; D. Heat exchanger C6H12 outlet; E. Endothermic reactor outlet; F. Heat exchanger reactant mix outlet; G. Endothermic reactor exhaust compressor (E.R.E.C.) outlet; H. Reactant mix condenser/evaporator/cooler outlet; I. Separator H2 gas outlet; J. Separator liquid outlet; K. Hydraulic expander outlet to liquid/liquid separator and liquid storage.

FIG. 2 is a work diagram of a second possible approach to constructing a B/E endothermic cycle segment as applicable to both the generation of endothermic fluid for use in a BB cycle and the generation of net work out. The following key is provided for FIG. 2: A. C6H12 storage outlet; B. C6H12 pump outlet; C. C6H12 Condenser/evaporator/cooler outlet; D. Heat exchanger C6H12 outlet; E. Endothermic reactor outlet; F. Heat exchanger reactant mix outlet; G. Endothermic reactor exhaust compressor (E.R.E.C.) outlet; H. Reactant mix condenser/evaporator/cooler outlet; I. Separator H2 gas outlet; J. Heat exchanger H2 gas outlet; K. H2 expander #1 (high temperature) outlet; L. H2 expander #2 (low temperature) outlet; M. Separator liquid outlet; N. Hydraulic expander outlet to liquid/liquid separator and liquid storage.

Several other means of constructing B/E endothermic and exothermic cycle segments capable of producing net work out are referentially included from US Patent Application #18-0954634.

### DETAILED DESCRIPTION

It is proposed that reversible endothermic and exothermic fluid thermochemical means be used for efficiently storing and utilizing H2 in the form of a thermochemical battery rather than an electrochemical battery. An example of an endothermic fluid is cyclohexane (C6H12). An example of an exothermic fluid is benzene (C6H6) plus hydrogen (H2). Since the process revolves around the use of benzene (C6H6) as a means of cyclically storing and giving off H2, the process is termed the “Benzene Battery” (BB) cycle. By reversible is meant that the elements of a BB cycle are completely contained in a cyclical process that requires only the input and removal of thermal energy to continually operate. By allowing H2 to be stored in a liquid state at STP, the BB cycle is seen as useful for efficiently and inexpensively storing electricity and/or heat energy for later and/or distant use.

Additionally proposed is the use of a BB cycle as a means of making a Regenerating Fuel Cell (RFC) more practical. In an RFC system, water (H2O) is split by electrolysis. The resulting H2 and O2 are then stored. Later and or/distantly, the H2 and O2 are united in a fuel cell that regenerates the H2O and creates electricity, heat, and. An RFC is seen as useful as a means for storing electricity and heat energy. The stored components are H2O, O2 gas, and H2 gas. A BB RFC system differs in its ability to store the H2 in liquid form at STP, avoiding the need to store the H2 as either a highly compressed gas or as exceedingly cold H2. It is also advantaged over the use of storage by metal hydrides by the ability to store and/or transport H2 in liquid form at STP.

Additionally being proposed is the use of an Endothermic/Exothermic Reactor Exhaust Compressor or E.R.E.C. as a means of increasing the overall efficiency of a BB cycle. The concept of the E.R.E.C as applied to increasing the efficiency of a B/E-CHP or B/E-CC exothermic segment was proposed in US Patent Application #18-0954634. It is herein proposed as a means as well of increasing the efficiency of the endothermic segment of a B/E-CHP cycle, B/E-CC cycle or BB cycle.

Additionally proposed is the use of part or all the stored H2 as a fuel which is released by an endothermic fluid's conversion to exothermic fluid. The H2 fuel may be combusted as a means of supplying the endothermic thermal energy required for the release of the H2 from the endothermic fluid. This application of the BB cycle is seen as useful for allowing the release of H2 regardless of the local availability of a sufficiently high temperature source of thermal energy to drive he endothermic catalytic process. The H2-generated heat may be used directly or it may take the form of waste heat from an H2 combustion engine or process.

Additionally proposed is the use of heat proceeding from H2 fuel being combusted as a means of supplying the endothermic thermal energy required to drive a B/E-CC endothermic segment engine system.

The BB Cycle

In a BB cycle, H2 is generated at some location by some means. An exothermic segment, such as one described in US Patent Application #18-0954634, is used to store the H2 by the exothermic conversion of a fluid mix, such as C6H6+3H3, into an endothermic fluid, such as C6H12. The endothermic fluid is then stored until it is required. It may then be removed from storage and reconverted into the exothermic fluid by passing it over a catalyst at some pressure and temperature.

The BB cycle concept is defined by the following theoretically reversible chemical processes:

6H2O+energy=6H2+O2;6H2+2C6H6=2C6H12&energy;2C6H12+energy=2C6H6+6H2;6H2+3O2=6H2O&energy

Taken separately:

6H2O+energy=6H2+O2

That is, water is separated with energy (usually electrical) into hydrogen and oxygen.

6H2+2C6H6=2C6H12&energy

Hydrogen gas is thermo-chemically bound to benzene to produce cyclohexane and energy.

2C6H12+energy=2C6H6+6H2

Cyclohexane is thermo-chemically separated with energy to produce benzene and hydrogen.

6H2+3O2=6H2O&energy

Oxygen and hydrogen are electrically or thermo-chemically bound to produce water and energy.

Ignoring the energy constituent, the BB cycle can be written as

6H2O↔6H2+3O2↔(3O2)+2C6H6+6H2↔(3O2)+2C6H1

where↔indicates a theoretically reversible process.

Ignoring the O2, which might not require storage in all instances, the BB cycle can be written

6H2O↔6H2↔2C6H6+6H2↔2C6H12

which simplifies to

3H2O↔3H2↔C6H6+3H2↔C6H12

The critical stored components of a BB cycle are thus H2O, C6H6, and C6H12, all of which may be stored as liquids at STP. O2 gas must also be stored unless it is readily available, such as within Earth's atmosphere. Note that H2 is essentially thermo-chemically stored as a liquid at STP.

The 2009 NASA RFC Proposal

In February of 2009 or earlier, NASA proposed an RFC system for use on the lunar surface, as disclosed in a slide show available on the NASA website:
NASA JSC Lunar Surface Concept Study Lunar Energy Storage
NNJ08TA84C
U.S. Chamber of Commerce Programmatic Workshop
26 Feb. 2009
Dr. Cheng-Yi Lu, Jim McClanahan
Hamilton Sundstrand Energy, Space & Defense, Rocketdyne
https://www.nasa.ciov/pdf/315858main Chenci-yi Lu.pdf

The NASA RFC systems may be generally defined by the following theoretically reversible chemical process:

2H2O+energy=2H2+O2;2H2+O2=2H2O&energy

Specifically, in the NASA RFC systems, water is split by electrolysis powered by solar energy over the two week long lunar “day”. The resulting H2 and O2 are then stored. Over the two week long lunar “night”, the H2 and O2 are united in a fuel cell that creates electricity and heat. The stored components are H2O, H2 gas, and O2 gas.

In the 2009 NASA analysis, five different approaches for storing the H2 and O2 gases for an RFC are discussed: four high pressure (NASA H P System), and two cryogenic (NASA Cryo RFC system). H2 and O2 are compressed in high pressure tanks in the NASA H P RFC system approach. In the NASA Cryo RFC system approach, H2 and O2 are stored as liquids, reducing the mass of the overall system by greatly reducing the tank mass. Per slide 51, the two systems, which are intended to produce ˜1,770 kWe of stored electrical energy for use during the 2 week long lunar night, will have a specific energy (power density) of 434, 509, and 598 W-hr/kg for the NASA H P RFC system versions, and 913 and 1,153 W-hr/kg for the NASA Cryo RFC system versions.

The NASA H P RFC system includes 3,238, 2,732, and 2,312 kg for tanks. The RFC NASA Cryo system reduces tank masses to 467 and 393 kg. The top end NASA Cryo RFC system also includes 104 kg for drying/liquification equipment, 267 kg for power for cryogenic storage, and 10 kg for additional radiator and piping mass, or a total additional mass of 381 kg. Total system mass is also given. Total mass for the NASA H P RFC system equaled 4,607, 3,931, and 3,347 kg. Total mass for the NASA Cryo RFC systems equaled 2,191 and 1,760 kg. The large difference in power density for the two NASA RFC systems clearly comes down to the greater mass of pressurized storage tanks, as shown on slide 51.

The proposed NASA RFC power plant was predicted to provide 6.4 kW-h of electricity on the lunar surface during periods of zero solar insolation. To convert H2 and 02 back into electricity will always yield significantly less than 100% electricity. For 6.4 kW-h of electricity output, a 70% fuel cell conversion rate was assumed in the 2009 NASA analysis (sheet 51). That would require (6.4/0.7=) 9.1 kW-h output of H2, assuming the low heat of H2 combustion or 33.3 kW-h/kg. That in turn equates to an H2 mass requirement of 0.273 kg/hour of H2. It is known that, for the NASA RFC, 87 kg of liquid H2 and 692 kg of liquid O2 was proposed for a total of 779 kg of “exothermic fluid”. That would equate to 318 hours or about 13.3 days of power, which would be about right for the approximately 2 weeks that most of the lunar surface goes without sunlight during the lunar night.

The BB RFC System

The operation of the a BB RFC would exactly match that of the BB cycle, with the additional requirement that the H2 generated would power an RFC. As a result, making comparisons between the two proposed systems is relatively simple.

Practicality Comparison:

If C6H6 is used to store H2 on one side and the H2 is directly released into an H2 oxidizer on the other side, the need to store H2 as either a very cold liquid or as a very high pressure gas is eliminated.

Specific energy (power density) comparison:

On the lunar surface, specific energy is extremely important. Assuming the SpaceX Starship is used, to put an object on the lunar surface requires approximately 300 times its mass on the Earth's surface. From above, the specific energy for the to produce 1,770 kWe of stored electrical energy for use during the 2 week long lunar night, will have a specific energy (power density) of 705 W-hr/kg for the NASA H P RFC system version and 1,153 W-hr/kg for the NASA Cryo RFC system version.

At Standard Temperature and Pressure (STP) (1 atm and 273.14 K (491.7° R)), C6H12 (liquid) has a mass of 84.16 g/mol. C6H6 (liquid) has a mass of 78.11 g/mol. The difference, or 6.05 grams, is essentially equal to 3 moles of H2, which has a mass of 2.02 g/mol.

The total mass of H2 required for electrolysis, as in the NASA RFC, equals 87 kg of H2. For a BB RFC system, that would require 43,000 moles of H2. At 3 moles per mol of C6H12, total C6H12 required equals 1,108 kg, or (1108/779=) 1.4× the mass of the NASA RFC exothermic fluid.

A comparison of the NASA H P RFC, NASA Cryo RFC, and a “BB Cryo RFC” system that takes into account the ability to store H2 as a liquid would essentially “borrow” from both NASA systems. For liquid O2 storage, a more massive tank would be required than for the C6H6 and C6H12 storage tank or tanks. Also, less mass would be required for the BB Cryo RFC system than for those systems required by the NASA Cryo RFC system but not required for the NASA H P RFC system.

It is known that, for the NASA RFC, 87 kg of liquid H2 and 692 kg of liquid O2 were proposed. The total mass for both H2 and O2 cryogenic storage tanks is estimated at 393 kg. The individual mass for the H2 and O2 tanks is not given. However, we know that liquid H2 has a density of 70.85 g/L and that liquid O2 has a density of 1.141 kg/L. For 87,000 g of liquid H2, volume would equal (87,000/70.85=) 1,228 L. For 692 kg of liquid O2, volume would equal (692/1.141=) 606 L. That is an H2 to O2 volume ratio of (1,228/606=) about 2 to 1. Since H2 must be far more extensively insulated than O2, and since pressure is not an issue, it is reasonable to assume that the H2 tank has twice the mass of the O2 tank, and is thus equal to about (393/3=) 131 kg. Assuming a single storage tank with a separator can be used to store both the C6H6 and the C6H12, and especially since it would not be necessary to store those liquids at cryogenic temperatures, it can be assumed that the tank would have about the same or less mass ratio as the liquid O2 tank. Since that ratio equals 5.28:1, the mass of the C6H12/C6H6 storage tank would equal about 354 kg.

For the BB Cryo RFC cryogenic O2 storage system, additional mass will be considered equal to about half of the NASA Cryo RFC system, or about 190 kg. Total tank and extra cryo system mass would thus equal: Liquid O2 tank mass+Liquid C6H12/C6H6 tank mass+incidental cryogenic mass, or (131+354+190=) 676 kg.

In all other respects, the mass for the “BB Cryo RFC” system (with cryogenic O2 storage) would equal the mass of the NASA H P RFP system. Replacing tank mass for the NASA H P RFP system leaves 1,369 kg. Adding BB Cryo RFC tank plus incidental cryogenic mass (676) and the C6H12 mass (1,108 kg) equals a total mass for the BB Cryo RFC system of 3153 kg.

How does that compare to the NASA Cryo RFC system? At 1.137 kW-h/kg and a 1,760 kg mass, total power output equals 2001.12 kW-h The BB Cryo RFC system therefore has a specific power of 0.631 kW-h/kg, or masses about 80% more than the NASA Cryo RFC system.

However, the BB Cryo RFC system requires something the NASA Cryo RFC system doesn't: It requires a heat source at a sufficient temperature to release the H2 from endothermic fluid. This is a critical difference, since there are times when a source of sufficiently high temperature thermal energy is not available to disassociate the endothermic fluid. In the application that NASA is considering, the H2 needs to be released during the lunar night.

The BB RFC Self-Heating System

It is proposed that combustion of part of the H2 released by the endothermic fluid's conversion to exothermic fluid be used to supply the endothermic thermal energy required to release H2 from the endothermic fluid.

Assuming the low heat of combustion, 1 kg of H2 has a combustion value of ˜120,000 kJ (33.33 kW-h), or 120 kJ/gram (0.0333 kW-hour, 0.000555 kW-minute). 1 mol of C6H12 can release 3 moles or 6.06 g or H2. The combustion of 6.06 grams of H2 can theoretically supply 727 kJ. Since the combustion of 6.06 grams of H2 can theoretically supply 727 kJ, it is feasible to combust 30% of the H2 released by the endothermic fluid's conversion to supply the endothermic thermal energy required to release H2 from the endothermic fluid, thus liberating 70% of the H2 in the exothermic fluid, or approximately 4.234 grams (2.1 moles) of H2 per mol of C6H12. For the C6H12>C6H6+3H2 reaction, the required chemical temperature of reaction at 1 atmosphere is about 820 K (1,476 R, 547 C 1,016 F). However, the combustion of H2 can release thermal energy at a far higher temperature than that, so achieving the required temperature for thermochemical conversion is not an issue.

Unfortunately, decreasing the amount of available H2 per kg of C6H12 has two direct negative impacts on specific energy. First, it will require 30% more C6H12 for a given power output. Second, it will increase the amount of solar energy required to create the electricity to create a 30% increase in H2. The first impact will essentially increase the relative mass and thus the specific energy by 30%. That will increase the calculated specific energy for the BB Cryo RFC to 4,099 kg.

The BB with B/E-CC Self-Heating System

It seems clear that combusting 30% of the H2 released would appear to add inefficiency to a BB RFC. However, there is an alternative approach that can theoretically maintain specific power, and that is through the use of a Combined Cycle (CC) power plant

From https://en.wikipedia.org/wiki/Combined_cycle_power_plant: “A combined cycle power plant is an assembly of heat engines that work in tandem from the same source of heat, converting it into mechanical energy.”

If 30% of the H2 released is used as fuel to release the other 70% of H2, the 30% of H2 can be used to power a combustion engine. A H2-powered diesel engine can achieve at least 45% thermal efficiency. If an H2 combustion engine produced work with a 45% efficiency, and the 55% “waste” heat from that engine powered a bottoming cycle engine that also produced work with a 45% efficiency, then the overall efficiency of the CC engine would equal 45% plus another 45% of 55%. That is, total overall efficiency would equal 69.75%.

In other words, since the engine was producing the same efficiency as the fuel cell, it would make sense to simply use a larger CC engine to convert 100% of the H2. Such a BB CC system could thus theoretically maintain specific energy of about 630 W-h/kg.

In US Patent Application #18-0954634, a novel B/E-CC engine was proposed. By looking at the original B/E cycle as a combination of two engines, one being based on an endothermic segment and one being based on an exothermic segment, a theoretical CC “bottoming” engine was examined with a theoretical efficiency of about 46%. Since then, it appears to be possible to increase that theoretical efficiency.

BB RFC with RFC-Powered Heating System

In the NASA analysis referenced above, a 70% fuel cell efficiency was indicated. In theory, 30% of the potential energy is still available as waste heat, which exactly equals the energy required to drive an endothermic catalytic reduction of C6H12 to C6H6+3H2. If the temperature of that waste heat is sufficient to drive the endothermic reaction, even if no net work were developed, then the overall efficiency would still equal 70%. If the reaction were to take place at a small fraction of 1 atmosphere of pressure, then the required temperature could be reduced. At 1/100th of an atmosphere, the endothermic temperature requirement for a 99% conversion would equal about 600 K, and even larger pressure drops would continue to drop the required temperature for conversion.

BB RFC with B/E Cycle Endothermic Segment Expansion

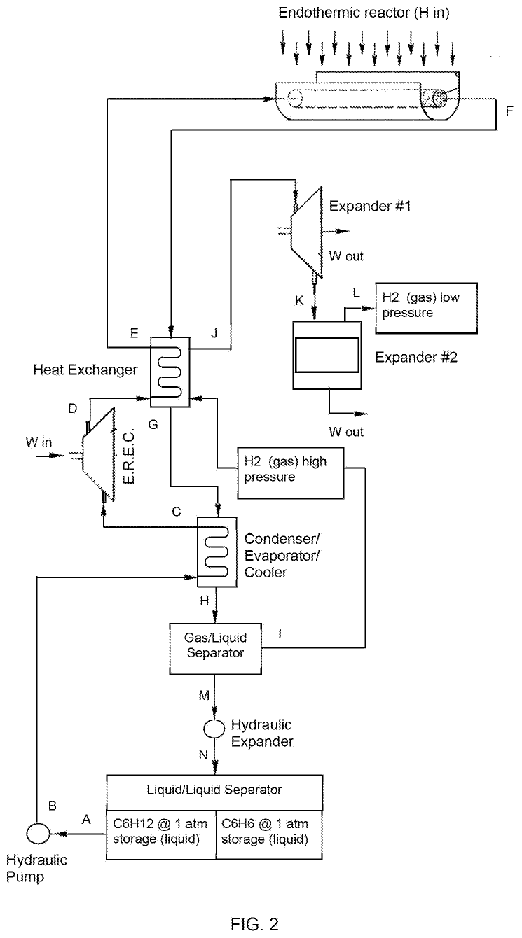

There is one other approach to maintaining specific energy which is directly attributable to the Bland/Ewing Cycle as proposed in U.S. Pat. No. 3,225,538. In addition, US Patent Application #18-0954634 proposes that an endothermic segment can be a stand-alone heat engine. FIG. 2 illustrates one example of such an endothermic segment. Also, In US Patent Application #18-0954634, FIG. 3 illustrates such a segment. These two Figures can be used to illustrate the points.

Per the concept of the Bland/Ewing Cycle, an endothermic conversion of, for example, C6H12 product to C6H6+3H2 reactant occurs at constant temperature and constant pressure but at expanding volume. In fact, with 100% conversion of a quantity of C6H12 product, the conversion in volume is exactly equal to 1:4. That represents work out.

Note that in US Patent Application #18-0954634, FIG. 3, the actual change due to a conversion from endothermic fluid to exothermic fluid is shown as a single point. There are two peak temperatures shown in FIG. 3 and one pressure, indicated by the numbers 5, 8, and 9 for the lower temperature and 16, 17, 18, 6, and 7 for the higher temperature. To plot the change in volume on this graph would require an x, y, and z axis, with the x and y axes as shown and the z axis inferred. Thus, if the volume is 305 L (0.35 m3) before the conversion, it is 1,220 L after. If the pressure is 5.25 atm (532 kPa), then (1.22 m3). Clearly, work is being generated.

It may also be shown that, theoretically, the latent heat of just the vaporous C6H6 reactant, if passed in heat exchange with the C6H12 product, can supply all the thermal requirements to raise the product to the temperature of the endothermic reactor, including the thermal requirement to vaporize the C6H12, assuming a negligible amount of work in by a device called an E.R.E.C.. And because, per US Patent Application #18-0954634, a simple pump may be used to pressurize the endothermic fluid, there is only a negligible amount of pumping work required.

Even more usefully, the H2, if it could be separated out, for example by the process shown in FIG. 2, or possibly by “filtering” through a palladium molecular sieve, can be separately expanded adiabatically to take out even more work.

There are other techniques for gaining efficiency, such as using uncooled expanders and low friction bearings. And there is the possibility, as suggested in U.S. Pat. No. 3,871,179, to use a constant volume heat exchange process rather than a constant volume heat exchange process.

Finally, note that the efficiency at which work is produced by any heat engine, including an endothermic segment engine system, is directly determined by the temperature at which the engine is operated, and the temperature at which H2 can be combusted is extremely high.

For all these reasons, there is reason to expect that, by using a BB RFC with B/E cycle endothermic segment expansion, a full conversion of endothermic fluid is possible and much of the decrease in specific energy due to the 30% combustion requirement can be reversed.

### Specification—Detailed Description—First Embodiment—BB Cycle

The BB cycle concept can be defined as

6H2O+energy=6H2+O2

That is, water is separated with energy (usually electrical) into hydrogen and oxygen.

6H2+2C6H6=2C6H12&energy

Hydrogen gas is thermo-chemically bound to benzene to produce cyclohexane and energy.

2C6H12+energy=2C6H6+6H2

Cyclohexane is thermo-chemically separated with energy to produce benzene and hydrogen.

6H2+3O2=6H2O&energy

Oxygen and hydrogen are electrically or thermo-chemically bound to produce water and energy.

The critical stored components of a BB cycle are thus H2O, C6H6, and C6H12, all of which may be stored as liquids at STP. O2 gas must also be stored unless it is readily available, such as within Earth's atmosphere. Note that H2 is thermo-chemically stored as a liquid at STP.

In addition to these components, a BB cycle requires a heat source at a sufficient temperature to release the H2 from endothermic fluid.

### Specification—Operation—First Embodiment—BB Cycle

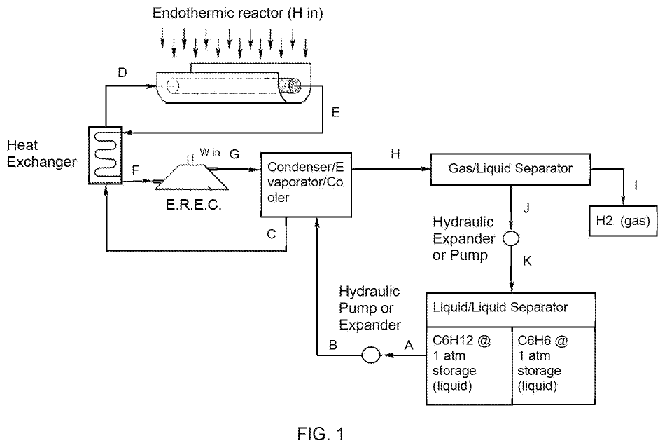

In FIG. 1, point A, C6H12 is shown leaving the storage system. Note that C6H12 is shown as a liquid at STP.

In FIG. 1, point B, the C6H12 has been compressed or expanded to some desired pressure.

In FIG. 1, point C, the C6H12 has been passed through an evaporator, converting from a liquid to a low temperature gas.

In FIG. 1, point D, the C6H12 has been passed through a heat exchanger, exchanging heat from the converted product exiting the endothermic reactor. Note that, as indicated above, no work is generated by this particular endothermic cycle segment. However, as noted in US Patent Application #18-0954634, other endothermic cycle segments are possible that produce net work.

In FIG. 1, point E, the C6H12 has been passed through the endothermic reactor, chemically absorbing ˜2,340 kJ/kg (0.65 kW-h) of thermal energy. Per U.S. Pat. No. 3,225,538, FIG. 1, at 1 standard atmosphere, a 90% conversion endothermic reaction requires a temperature of about 810 K (1,458 R, 536.9 deg C, 998.3 deg F). At 100 standard atmospheres, a 90% conversion endothermic reaction requires a temperature of about 1,400 K (2,520 R, 1,127 deg C 2,060 deg F). At 0.01 atmospheres, a 99% conversion endothermic reaction of C6H12 to C6H6+3H2 requires a temperature of about 600 K (1,080 R, 327 deg C, 620 deg F).

In FIG. 1, point F, the reactant mix, composed of C6H6, H2, and some remnant C6H12, has been passed back through the heat exchanger, cooling the reactant mix and preheating the C6H12.

In FIG. 1, point G, the reactant mix has been passed through an E.R.E.C., where its pressure is raised sufficiently that condensation of the vapor contents will be at a high enough temperature to evaporate inflowing liquid C6H12, thus reducing the amount of source heat required to operate the process.

In FIG. 1, point H, the reactant has been passed through the condenser/evaporator/cooler.

FIG. 1, point I, the gaseous H2 has been separated from the liquid constituents.

In FIG. 1, point J, the liquids will pass through the expander/compressor, returning the liquids back to STP.

In FIG. 1, point K, the liquid C6H12 and C6H6 are separated and sent to their respective storage tanks.

To complete the cycle, the exothermic fluid (C6H6 in this example) is recharged with H2.

### Specification—Detailed Description—Second Embodiment—E.R.E.C

In the application of the E.R.E.C. to the exothermic segment as proposed in US Patent Application #18-0954634, Claim 4 (revised), the E.R.E.C. was used to compress C6H6 (an olefin/alkene) to a slightly higher pressure following vaporization, such that when the C6H12 (a paraffin/alkane) exiting the exothermic reactor was passed in heat exchange with the lower pressure C6H6, the C6H12 was able to condense at a higher temperature than the C6H6 required for vaporization, thus substantially reducing the thermal energy otherwise required by the exothermic segment.

In the proposed application, an E.R.E.C. is used to compress a paraffin/alkane (C6H12) to a slightly higher pressure following vaporization, such that when an olefin/alkene (C6H6) exiting the endothermic reactor is passed in heat exchange with the lower pressure paraffin/alkane the olefin/alkene is able to condense at a higher temperature than the paraffin/alkane requires for vaporization, thus substantially reducing the thermal energy otherwise required by the endothermic segment.

### Specification—Operation—Second Embodiment—E.R.E.C

In US Patent Application #18-0954634, under “Specification—Operation—Fourth Embodiment—B/E-CHP-H”, steps for an endothermic half-cycle are given, referencing FIGS. 3, 4 and 7:

Referencing FIG. 2:
A. C6H12 storage outlet—(14.a) 0.454 kg & 586.6 cm3 of liquid product (C6H12) at 344 K and 1 atm is made available to a C6H12 pump.
B. C6H12 pump outlet—(14.b) The product is pumped from storage and into the cycle at 5.1 atm. A negligible amount of work is required.
C. C6H12 Condenser/evaporator/cooler outlet—(15.) The 0.454 kg of liquid product at 5.1 atm is raised to vapor-liquid equilibrium at approximately 423 K by exchanging heat with 0.454 kg of counter-flowing reactant product at 5.25 atm; a heat of vaporization of 130 kJ is estimated for 0.454 kg of C6H12 at 5.1 atm, and a heat of condensation of 164 kJ for C6H6 and remnant C6H12 at 5.25 atm is estimated. Since the temperature of vapor-liquid equilibrium for C6H6 (353.2 K at 1 atm) is estimated at only slightly less than the temperature of vapor-liquid equilibrium for C6H12 (353.9 K at 1 atm), the heat content released by C6H6 and remnant C6H12, being released at a higher temperature due to the higher pressure, will vaporize 100% of the 0.0454 kg of C6H12 product exhausting from the condenser/evaporator/cooler. No source heat will be required for the vaporization.
D. Endothermic reactor exhaust compressor (E. R. E. C.) outlet—The vaporous product is raised to a higher pressure, for example 5.25 atm. A negligible amount of work is required.
E. Heat exchanger C6H12 outlet—(16.) In the preheater (heat exchanger #3), the product is raised at constant pressure to 950 K.
F. Endothermic reactor outlet—(17.) The product at 5.25 atm is converted in the endothermic reactor to the reactant (10% C6H12 and 90% C6H6+3H2 at 950 K), absorbing heat thermo-chemically and storing potential heat energy equal to 1,062 kJ. Note that the conversion is accomplished at constant pressure and temperature.
G. Heat exchanger reactant mix outlet—(18. & 21.) The reactant then passes through the counterflow heat exchanger, where the product will be cooled to about 450 K by inflowing vaporized product entering the counterflow at about 425 K.
H. Reactant mix condenser/evaporator/cooler outlet—(22.) The 5.25 atm reactant stream then flows through the condenser/cooler (heat exchanger #4.1, where it is cooled back to 423 K (or lower).
I. Separator H2 gas outlet—(23.a) The reactant is then separated into liquid and gaseous constituents. The H2 is sent back through the heat exchanger (see L below), while the C6H6 plus remnant C6H12 is sent to the hydraulic expander (see N below).
J. Heat exchanger H2 gas outlet—(19.) The 5.1 atm H2 is then exhausted from the heat exchanger at 950 K and into (high temperature) expander #1.
K. H2 expander #1 (high temperature) H2 outlet—(20.) The H2 reactant at 950 K is then exhausted from (high temperature) expander #1 and into #2 (low temperature) expander, producing work.
L. H2 expander #2 (low temperature) H2 outlet—The H2 reactant is then exhausted from #2 (low temperature) expander at approximately 1 atmosphere, producing work. Note that any remaining thermal excess is available for increasing thermal input to the pre-expansion working fluids.
M. Separator liquid outlet—(23.b) The liquid reactant constituents (10% C6H12 and 90% C6H6) and 5.25 atmospheres are separated and expanded within the hydraulic expander to 1 atmosphere.
N. Hydraulic expander outlet to liquid/liquid separator and liquid storage—The liquid reactant constituents at 1 atmosphere are then separated into liquid product and reactant constituents (C6H12 and C6H6) and sent to storage.

### Specification—Detailed Description—Third Embodiment—BB RFC System

As stated above, in essence, a BB cycle may be generally defined as

3H2O↔3H2↔C6H6+3H2↔C6H12

In essence, an RFC system may be generally defined by the following theoretically reversible chemical process:

2H2O+energy=2H2+O2;2H2+O2=2H2O&energy

That is, water is separated with energy (usually electricity) into hydrogen and oxygen; hydrogen and oxygen are converted to water, generating energy. That is, water is separated with energy (usually electricity) into hydrogen and oxygen; hydrogen and oxygen are converted to water, generating energy.

Shown with energy removed, the cycle simplifies to

2H2O↔2H2+O2

Increasing the moles transferred in the standard RFC system equals

6H2O↔6H2+3O2

For a standard RFC, the stored components are H2O, O2 gas, and H2 gas.

Unfortunately, gases in general are difficult to store in quantity, and H2 is perhaps the most difficult of all gases to store. A BB cycle is proposed as a means of solving this storage problem. As shown above, the addition to

6H2O↔6H2+3O2

of

(3O2)+2C6H6+6H2↔(3O2)+2C6H1

equals

6H2O↔6H2+3O2↔(3O2)+2C6H6+6H2↔(3O2)+2C6H1

which equates to

6H2O+energy=6H2+O2;6H2+2C6H6=2C6H12&energy;

2C6H12+energy=2C6H6+6H2;6H2+3O2=6H2O &energy

Therefore, for a BB RFC, the critical stored components are H2O, C6H6, and C6H12, all of which may be stored as liquids at STP. O2 gas must also be stored unless it is readily available, such as within Earth's atmosphere. That is, the BB RFC system differs in its ability to store the H2 in liquid form at STP, avoiding the need to store the H2 as either a highly compressed gas or as exceedingly cold H2 liquid. It is also advantaged over the use of H2 storage in metal hydrides by its ability to easily store and/or transport H2 in liquid form at STP.

In the BB RFC system, the BB cycle H2 storage technique is proposed as an alternative to the high pressure gas or liquid H2 storage techniques proposed in the NASA RFC concept. For example, three molecules of H2 may be stored in one molecule of benzene (C6H6) as cyclohexane (C6H12). Since C6H6 and C6H12 are both liquids, this essentially stores H2 in a liquid form. The generation of C6H12 (the endothermic fluid) from the catalytic reaction of C6H6+3H2 (the exothermic fluid) is an exothermic reaction, evolving a set quantity of heat per mol at a temperature that is totally dependent on pressure, with higher pressure generating higher temperature.

While heat is released when the exothermic fluid is combined to create the endothermic fluid, the generation of H2 from the endothermic fluid requires a thermal source. It is also, like the C6H6 plus H2 capture process, a function of temperature and pressure. In U.S. Pat. No. 3,225,538, Table I, chemical heat of reaction changes for C6H12↔C6H6+3H2 are given. In Table I, chemical heat change equals approximately 52.3 kilogram-calories/mol (kcal/mol) (219 kJ/mol) of C6H12 for both endothermic and exothermic reactions. The information given is for 1 atm (14.7 psi) constant pressure, but since heat is chemically stored, it would essentially be the same at any pressure or temperature driving the reaction.

Finally, note that exactly as much thermal energy is required to catalytically dissociate a mol of C6H12 into a mol of C6H6 and 3 moles of 3H2 as is given up during a catalytic conversion of a mol of C6H6 and 3 moles of 3H2 into a mol of C6H12. At any given pressure, the difference is only in the temperature of the reaction. Likewise, at any given temperature, the difference is only in the pressure of the reaction.

### Specification—Operation—Third Embodiment—BB RFC System

In operation, the operation of the a BB-RFC would exactly match that of the BB cycle, with the addition that the H2 generated would power an RFC.

### Specification—Detailed Description—Fourth Embodiment—BB RFC Self-Heating System

There are times when a source of sufficiently high temperature thermal energy are not available to disassociate the endothermic fluid. For example, in the application that NASA is considering, the H2 needs to be released during the lunar night.

It is proposed that combustion of part of the H2 released by the endothermic fluid's conversion to exothermic fluid be used to supply the endothermic thermal energy required to release H2 from the endothermic fluid.

As mentioned earlier, for C6H12>C6H6+3H2, the required chemical temperature of reaction is about 820 K (1,476 R, 547 C 1,016 F). At Standard Temperature and Pressure (STP) (1 atm and 273.14 K (491.7° R)), C6H12 (liquid) has a mass of 84.16 g/mol. C6H6 (liquid) has a mass of 78.11 g/mol. The difference, or 6.06 grams, is equal to 3 moles of H2, which has a mass of 2.02 g/mol. Assuming the low heat of combustion, 1 kg of H2 has a combustion value of ˜120,000 kJ (33.33 kW-h), or 120 kJ/gram (0.0333 kW-hour, 0.000555 kW-minute).

Since the combustion of 6.06 grams of H2 can theoretically supply 727 kJ, it is feasible to combust 30% of the H2 released by the endothermic fluid's conversion to supply the endothermic thermal energy required to release H2 from the endothermic fluid, thus liberating 70% of the H2 in the exothermic fluid, or approximately 4.234 grams (2.1 moles) of H2 per mol of C6H12. Assuming a 90% conversion efficiency, 1 mol of circulated C6H12 would thus produce 1.886 moles of H2 massing 3.811 grams for use elsewhere, leaving 0.1 mol of C6H12 and 0.9 moles of C6H6 for circulation out of the exothermic fluid.

### Specification—Operation—Fourth Embodiment—BB RFC Self-Heating System

In operation, the operation of the a BB-RFC self-heating system would exactly match that of the BB cycle as shown in FIG. 1, with the addition that (1) 70% of the H2 generated would power an RFC, and (2) 30% of the H2 generated would power the BB-RFC itself.

### Specification—Detailed Description—Fifth Embodiment—BB RFC with B/E Cycle Endothermic Segment Expansion

Clearly, combusting 30% of the H2 released would appear to add inefficiency to a BB RFC. However, it is possible to reduce that inefficiently if the thermal energy of combusting 30% of the H2 released is being directed specifically at converting an endothermic fluid into an exothermic fluid. In other words, if all source heat goes directly into the endothermic reaction, the full 30% of endothermic fluid is converted into exothermic fluid. At the same time, work out will still be generated by a Bland/Ewing Cycle endothermic segment engine, as discussed above. In addition, the efficiency by which the exothermic fluid is produced can easily be increased by raising the temperature at which the reaction is made to take place, and the combustion of H2 can create extremely high temperatures.

In the original Bland/Ewing cycle proposed in U.S. Pat. No. 3,225,538, it may be recalled that one molecule of C6H12 was to be compressed but 4 molecules of exothermic mix were to be expanded. In essence, a method is herein being proposed to take advantage of exactly that thermochemical expansion process.

In US Patent Application #18-0954634, FIG. 3, it was proposed that the endothermic segment of a B/E-CC cycle be decoupled from the exothermic segment to create useful net work. While the theoretical thermal efficiency made possible was relatively low in that engine (22.5%), analysis of more recent variants of B/E-CC heat engines indicate significantly higher potential thermal efficiencies. In one variant, a theoretical thermal efficiency of 44% was determined, with the potential for even higher theoretical thermal efficiencies.

### Specification—Operation—Fifth Embodiment—BB RFC with B/E Cycle Endothermic Segment Expansion

In operation, one possible version of a BB-RFC with B/E endothermic segment-powered self-heating system would resemble the BB cycle as shown in FIG. 2, with the addition that (1) 70% of the H2 generated would power an RFC, and (2) 30% of the H2 thus generated would power the BB-RFC itself. See “Specification—Operation—Second Embodiment—E.R.E.C.” above.

### Specification—Detailed Description—Sixth Embodiment—BB RFC with RFC-Powered Heating System

Alternatively, it is possible that a fuel cell may itself produce exhaust heat at a sufficient temperature to drive a catalytic reaction such as is shown in FIG. 1 or FIG. 2. To accomplish that, it is proposed that the pressure at which the endothermic catalytic reaction is initiated is reduced to a small fraction of an atmosphere, and that an E.R.E.C. be used to increase overall thermal efficiency.

In the NASA analysis referenced above, a 70% efficiency was indicated. In theory, 30% of the potential energy is still available, which exactly equals the energy required to drive an endothermic catalytic reduction of C6H12 to C6H6+3H2, particularly if the reaction were to take place at a small fraction of 1 atmosphere of pressure. As noted above, at 1/100th of an atmosphere, the endothermic temperature requirement for a 99% conversion would equal about 600 K, and further pressure drops would continue to drop the required temperature for conversion.

### Specification—Operation—Sixth Embodiment—BB RFC with RFC-Powered Heating System

In operation, the operation of the one possible version of a BB-RFC with B/E endothermic segment-powered self-heating system would exactly match that of the BB cycle as shown in FIG. 1, with the addition that (1) 70% of the H2 generated would power an RFC, and (2) the 30% of the H2 thus generated that would power the BB-RFC itself would come from the waste heat of the RFC itself.

### Specification—Miscellaneous Descriptions and Operations

It is obvious that the BB cycle energy storage and delivery process has a potential usefulness beyond the lunar surface. In fact, it can easily be shown to represent a meaningful alternative to the present hydrocarbon-combustion processes that currently underpin much of the human race's energy generation and distribution network.
It is a cyclical process that is essentially driven by thermal energy, which can come from many and varied sources.
The basic constituents of the system are not “used up”, as with present hydrocarbon-combustion systems.
O2 is readily available in the atmosphere, as is H2O, and the “exhaust” from the process may be arranged to be pure H2O.
It is possible in some terrestrial applications to avoid liquifying, storing, and shipping liquid O2, meaning all the basic constituents of the system may be stored and transported in liquid form at STP.

For example, a process can be envisioned whereby:
1. H2 is generated at a solar site and captured in C6H6 as C6H12.
2. C6H12 is shipped to a service station.
3. The service station fills a transport's tank with C6H12 while emptying the same tank of C6H6 (a partition keeping the two liquids separate from one another).
4. The transport travels extensively, then goes to another service station where it receives a fresh tank of C6H12 and continues its journey.
5. The C6H6 is shipped from the service station back to the site where the H2 is being generated.

### Specification—Conclusion, Ramifications, and Scope

Other thermochemical cycles are possible, as disclosed in U.S. Pat. Nos. 3,225,538, 3,067,594, and 3,871,179, and therefore the C6H12+heat↔C6H6+3H2 cycle is used as a general example. Also, pressure and temperature define endothermic and exothermic processes of heat absorption and rejection. Accordingly, all calculations herein should be considered only useful as means of generally illustrating the larger findings herein.

1.-18. (canceled)

19. A method for efficiently and cyclically transporting hydrogen gas (H2) within a paraffin/alkane product (for example, cyclohexane or C6H12) comprised of (1) vaporizing a pre-pressurized quantity of liquid or solid olefin/alkene (for example, benzene or C6H6), (2) combining said vaporized olefin/alkene with pre-pressurized H2 gas from some source, (3) preheating in a first heat exchanger the resulting reactant to the temperature of an exothermic reactor capable of converting said reactant to a paraffin/alkane product at constant temperature and pressure, (4) passing said product exhausting from the exothermic reactor back through said first heat exchanger to preheat said reactant (5) cooling said product back to a liquid or solid state, (6) storing said product for later and/or distant use, (7) vaporizing at a later time and/or distant location a pre-pressurized quantity of said product at or slightly under the preferred pressure regime of an endothermic reactor, (8) preheating in a second heat exchanger said product to the temperature of said endothermic reactor capable, at constant pressure and temperature, of converting said product within said endothermic reactor into a reactant mix, (9) passing said reactant mix exhausting from said endothermic reactor back through said second heat exchanger to preheat said product, (10) cooling said reactant mix to the point where the olefin/alkene and remnant paraffin/alkane condense out of the H2 gas, (11) storing said liquid or solid olefin/alkene for later and/or distant use and (12) delivering said H2 gas to its end use.

20. The method of claim 19, where a small compressor means termed an Endothermic Reactor Exhaust Compressor (E.R.E.C.) is used to increase the pressure of the paraffin/alkane endothermic fluid product following vaporization and prior to preheating in said first heat exchanger, the higher pressure olefin/alkene plus H2 reactant flowing from the endothermic reactor, having been first used to help preheat the product in said first heat exchanger, then being passed through a third lower temperature counter-flowing heat exchange means, thus supplying the higher pressure and thus higher temperature heat of condensation within said third heat exchanger of the said olefin/alkene reactant component in such a manner as to convert the lower pressure endothermic product from a near-liquid, liquid, or solid state to or approaching a vaporous state.

21. The method in claim 19 whereby, following preheating the product in said first heat exchanger to the temperature of the endothermic reactor capable of converting the product within the endothermic reactor into a reactant mix at constant pressure and temperature, the reactant mix exhausting from the endothermic reactor is expanded prior to passing the reactant mix back through said first heat exchanger to preheat the product.

22. The method in claim 21 whereby, prior to expanding the reactant mix exhausting from the endothermic reactor, the reactant mix is superheated.

23. The method of claim 19, where part or all the H2 produced is fed to a fuel cell.

24. The method of claim 23, where the waste heat from said fuel cell is used in part or completely to power the endothermic reactor.

25. The method of claim 19, where part or all the H2 produced is fed to an H2 combustion engine.

26. The method of claim 25, where waste heat from said H2 combustion engine is used in part or completely to power the endothermic reactor.

27. The method of claim 19, where part or all of the H2 produced is recycled within an open or closed cycle Regenerative Fuel Cell Cycle.

28. The method of claim 19, where it is proposed that the cold pressurized H2 thus produced, being separated from the liquid elements, is stored by some means for future or distant use.

29. The method of claim 19, where it is proposed that the cold pressurized H2, being separated from the liquid elements, be reheated in part or totally, with otherwise-waste heat from the process.
